(19) United States
(12) Patent Application Publication
(10) Pub. No.: US 2024/0081373 A1
(43) Pub. Date: Mar. 14, 2024

(54) FEED FORMULATION CONTAINING SOYBEAN CURD RESIDUE AND METHOD FOR PREPARING THE SAME

(71) Applicant: MING CHI UNIVERSITY OF TECHNOLOGY, New Taipei City (TW)

(72) Inventor: Lo Tsui, New Taipei City (TW)

(73) Assignee: MING CHI UNIVERSITY OF TECHNOLOGY, New Taipei City (TW)

(21) Appl. No.: 18/141,426

(22) Filed: Apr. 30, 2023

(30) Foreign Application Priority Data
Sep. 8, 2022 (TW) 111134181

(51) Int. Cl. A23K 10/18; A23K 10/37; A23K 50/30; A23K 50/75; A23K 50/80

(52) U.S. Cl. CPC A23K 10/18; A23K 10/37; A23K 50/30; A23K 50/75; A23K 50/80

(57) ABSTRACT

The present invention mainly comprises a feed formulation containing soybean curd residue and a method for preparing the same. The preparation steps are as follows: (1) sterilization: sterilization of soybean curd residue; (2) preparation of a feed for black soldier fly: mixing the sterilized soybean curd residue with a solution of effective microorganisms; (3) preparation of a black soldier fly larvae powder: drying and grinding the black soldier fly larvae (BSFL) into powder; (4) addition of nutrients and BSFL powder: mixing the sterilized soybean curd residue with various nutrients and BSFL powder to obtain a mixture; (5) addition of the solution of effective microorganisms: mixing the solution of effective microorganisms with the mixture of step (4) to obtain a feed mixture; (6) fermentation: fermenting the feed mixture anaerobically to obtain a fermented feed, wherein the fermented feed is a feed formulation containing soybean curd residue.

### BACKGROUND OF THE INVENTION

### 1. Field of the Invention

The present invention relates to the technical field of feed formulations, in particular a feed formulation containing soybean curd residue and a method for preparing the same.

### 2. Description of the Prior Art

The current world population is 7.8 billion, and according to a United Nations report, the world population is expected to increase to 8.5 billion by 2030, to 9.7 billion by 2050, and to 11 billion by 2100. With rapid urbanization and population growth, global demand for food will also gradually increase, and it is estimated that by 2050, global demand for food will double compared to 2005. However, the demand for food is not the only thing that will increase. The amount of organic waste will also increase with the growth of the population, and a large amount of organic waste will also affect human health.

In addition, nearly one-third of the world's food is wasted and turned into food waste, and a huge amount of food waste becomes organic waste that needs to be treated. If food waste is not properly treated, it will cause environmental pollution and affect human health. Therefore, the decomposition of food waste has become a complicated problem that governments must deal with. At present, the most common waste disposal methods are landfill or incineration. However, the disposal of organic waste by these two methods will produce many greenhouse gases, including methane or carbon dioxide, which will increase the concentration of greenhouse gases in the atmosphere and are responsible for the greenhouse effect, which will lead to global warming and extreme climate phenomena, affecting the global ecological environment and threatening the survival of human beings.

However, due to different dietary habits, Asian people often consume soy-based products, and the Taiwanese are no exception. According to a study, Taiwan imports about 2.5 million tons of soybeans each year and produces about 420,000 tons of soybean curd residue, which used to be mixed with food waste and used as pig feed. However, with the growing severity of the African swine fever epidemic, the management of using food waste as pig feed has become one of the key issues for epidemic prevention. To strengthen the preparations for the prevention of African swine fever, county and municipal governments have started to ban feeding pigs with food waste, so the disposal of a large amount of soybean curd residue has become a critical issue that needs to be addressed.

According to previous studies, black soldier fly larvae can degrade a variety of organic matter and convert organic matter into biomass by digesting it. Black soldier fly larvae can survive in different environments and inhibit the growth of harmful microorganisms. The most important thing is that adult black soldier flies are not pests and do not transmit diseases. In the larval stage, black soldier flies mainly consume carbohydrates and proteins, so the content and quality of carbohydrates and proteins in the organic waste are very important factors for the growth of black soldier flies.

It was found that feeding black soldier fly larvae with fresh soybean curd residue supplemented with beneficial microorganisms can improve the cultivation efficiency of black soldier flies. However, because of the high protein content in soybean curd residue, soybean curd residue is easy to decay at room temperature, and adding beneficial microorganisms directly to the decayed soybean curd residue cannot show the effect of beneficial microorganisms on promoting the growth of black soldier fly larvae and livestock growth. Given the above, the inventors of the present invention have made great efforts in research and creation, and while using black soldier fly to decompose soybean curd residue, the inventors have developed and completed the feed formulation containing soybean curd residue and the method for preparing the same.

### SUMMARY OF THE INVENTION

The primary object of the present invention is to provide a method for preparing a feed formulation containing soybean curd residue and a feed formulation with black soldier fly protein prepared by the method, wherein the method mainly includes the following steps: (1) sterilization; (2) preparation of feed for black soldier fly; (3) preparation of black soldier fly larvae powder; (4) addition of nutrients and the black soldier fly larvae powder; (5) addition of a solution of effective microorganisms; and (6) fermentation. The present invention considers that the high nutritional content of soybean curd residue may spoil over a long time of storage, which is unfavorable to be used as animal feed. In the present invention, therefore, the soybean curd residue collected is firstly sterilized at a high temperature by the pasteurization method. One part of the sterilized soybean residue is used for cultivating black soldier fly larvae. In contrast, the other part of the sterilized soybean residue is used to prepare a feed formulation containing black soldier fly protein by a series of steps described above in the present invention. In addition, the method not only can decompose a large amount of organic waste of soybean curd residue that is difficult to deal with, but also the feed formulation containing black soldier fly protein prepared by the method comprises animal protein (fish bone powder), vegetable proteins (soybean curd residue, sesame residue, etc.), insect protein (black soldier fly larvae), and recycled minerals (oyster shells). The feed formulation containing black soldier fly comprises many beneficial ingredients for the growth of organisms and has very high nutritional value, and therefore is very suitable as feed for livestock, poultry, and aquatic animals.

To achieve the above object, in one aspect, the present invention provides a method for preparing a feed formulation containing black soldier fly protein, which includes the following steps:
(1) sterilization: sterilizing a soybean curd residue at 70° C. for 30 minutes to obtain a sterilized soybean curd residue, and dividing the sterilized soybean curd residue into two portions: a portion A and a portion B;
(2) preparation of a feed for black soldier fly: mixing the portion A with 5% w/w of a solution of effective microorganisms to obtain the feed for black soldier fly;
(3) preparation of a black soldier fly larvae powder: cultivating black soldier fly larvae on the feed for black soldier fly, collecting the black soldier fly larvae after 18 days of cultivation, and drying and grinding the black soldier fly larvae to obtain the black soldier fly larvae powder;
(4) addition of nutrients and the black soldier fly larvae powder: adding the black soldier fly larvae powder and the following nutrients to the portion B: rice bran, black sesame residue, fish bone powder, calcined oyster shell powder, rice husks, carbonized rice grain powder, maifan stone powder, fermented garlic, molasses, and mixing homogeneously to obtain a mixture, wherein every 100 kg of the mixture contains 20 kg of the portion B (20%), 40 kg of the rice bran (40%), 10 kg of the black sesame residue (10%), 6 kg of the black soldier fly larvae powder (6%), 6 kg of the fish bone powder (6%), 6 kg of the calcined oyster shell powder (6%), 5 kg of the rice husks (5%), 5 kg of the carbonized rice grain powder (5%), 1 kg of the maifan stone powder (1%), 0.5 kg of the fermented garlic (0.5%), and 0.5 kg of molasses (0.5%);
(5) addition of the solution of effective microorganisms: after the temperature of the mixture obtained in step (4) is cooled to below 45° C., one liter of the solution of effective microorganisms is added to the mixture and mixed homogeneously to obtain a feed mixture; and
(6) fermentation: fermenting the feed mixture obtained in step (5) anaerobically in an airtight plastic barrel for a period to obtain a fermented feed, wherein the fermented feed is the feed formulation containing black soldier fly protein.

In one aspect, the solution of effective microorganisms in step (2) and step (5) comprises lactic acid bacteria, yeast, photosynthetic bacteria, actinomycetes, acetic acid bacteria, and Aspergillus oryzae.

In one aspect, the nutrients in step (4) further comprise an additional agricultural waste, including banana scraps, tomato scraps, orange peels or carrot scraps.

In one aspect, the nutrients in step (4) further comprise a Chinese herbal medicine, including calendula, honeysuckle, marigold, Rhinacanthus nasutus (L.) Kurz, Chinese yam, dendrobium, turmeric, angelica, ganoderma or cordyceps.

In one aspect, the period for anaerobically fermenting the feed mixture in step (6) is 1 month.

In one aspect, the present invention provides a feed formulation containing soybean curd residue prepared by the method described above, in which the feed formulation containing black soldier fly protein further comprises an additional agricultural waste, including banana scraps, tomato scraps, orange peels or carrot scraps.

In another aspect, the feed formulation containing soybean curd residue further comprises a Chinese herbal medicine, including calendula, honeysuckle, marigold, Rhinacanthus nasutus (L.) Kurz, Chinese yam, dendrobium, turmeric, angelica, ganoderma or cordyceps.

In yet another aspect, the feed formulation containing soybean curd residue further comprises earthworm powder, so it has an annelid protein composition.

The above-mentioned feed formulation containing soybean curd residue can be used as feed for livestock, poultry, or aquatic animals because of its high nutritional value.

### BRIEF DESCRIPTION OF THE DRAWINGS

FIG. 1 shows a flow chart of a method for preparing a feed formulation containing black soldier fly protein according to the present invention.

### DETAILED DESCRIPTION OF THE PREFERRED EMBODIMENTS

Unless otherwise defined, all terms (including technical and scientific terms) used herein have the same meaning as commonly understood by one of ordinary skill in the art to which present inventive concepts belong. The present invention will be illustrated in more detail with the following exemplary embodiments; however, the present invention is not limited by these exemplary embodiments. Unless otherwise specified, the materials used in the present invention are commercially available and the following are only examples of commercially available routes.

### Exemplary Embodiment 1: Method for Preparing a Feed Formulation Containing Soybean Curd Residue

The scientific name of the Black Soldier Fly (BSF) used in the present invention is Hermetia illucens. The Black Soldier Fly belongs to Diptera in classification and is a saprophytic insect of Family Stratiomyidae, which can use poultry manure or decaying organic matter in the environment as a food source. The Black Soldier Fly is a tropical and subtropical insect that is native to Hawaii, USA and is widely distributed throughout the world (Between 40 degrees north and south latitude). In the larval stage, the black soldier fly accumulates all kinds of nutrients it needs and does not eat when it grows up to the stage that is ready to pupate. In addition, the adult black soldier fly does not eat and only needs water. Since the adult black soldier fly does not eat, there is no pathogenicity problem. Compared to other insects, black soldier fly larva contains higher levels of saturated fatty acids and protein (Ramos-Bueno et al., 2016), so the fatty acids and protein contained in its body can be utilized more effectively. The black soldier fly larvae used in the present application were obtained from Chiayi County Yimi Community College. Further, the black soldier fly larvae can be obtained from the wild by luring black soldier flies to lay eggs.

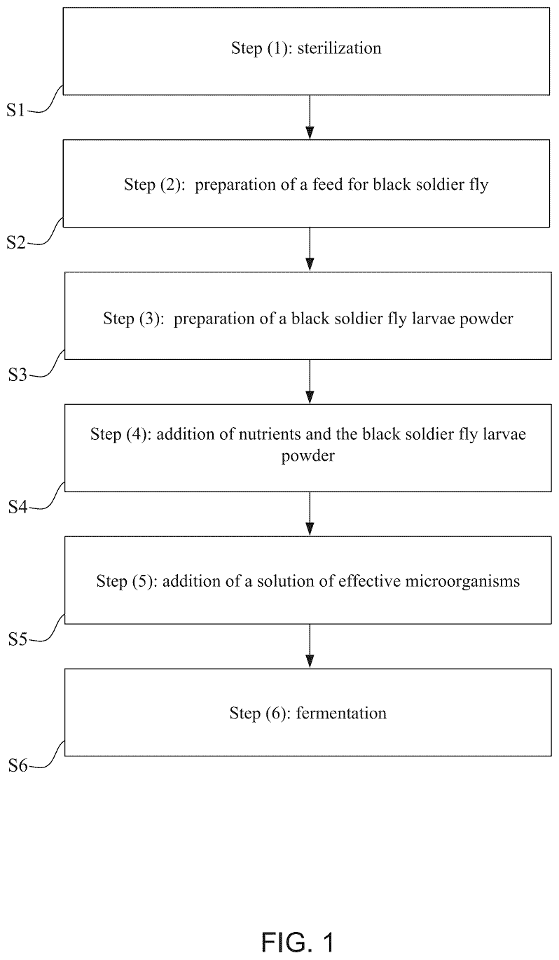

As shown in FIG. 1, a method for preparing a feed formulation containing soybean curd residue comprises the following steps:
S1 (Step (1) sterilization): sterilizing a soybean curd residue at 70° C. for 30 minutes to obtain a sterilized soybean curd residue, and dividing the sterilized soybean curd residue into two portions: a portion A and a portion B;
S2 (Step (2) preparation of a feed for black soldier fly): mixing the portion A with 5% w/w of a solution of effective microorganisms to obtain the feed for black soldier fly, wherein the solution of effective microorganisms comprises lactic acid bacteria, yeast, photosynthetic bacteria, actinomycetes, acetic acid bacteria, and Aspergillus oryzae and the portion A is mixed with 5% w/w of the solution of effective microorganisms when the temperature of the portion A is cooled to about 50° C.;
S3 (Step (3) preparation of a black soldier fly larvae powder): cultivating black soldier fly larvae on the feed for black soldier fly, collecting the black soldier fly larvae after 18 days of cultivation, and drying and grinding the black soldier fly larvae to obtain the black soldier fly larvae powder;
S4 (Step (4) addition of nutrients and the black soldier fly larvae powder): adding the black soldier fly larvae powder and the following nutrients to the portion B: rice bran, black sesame residue, fish bone powder, calcined oyster shell powder, rice husks, carbonized rice grain powder, maifan stone powder, fermented garlic, molasses, and mixing homogeneously to obtain a mixture, wherein every 100 kg of the mixture contains 20 kg of the portion B (20%), 40 kg of the rice bran (40%), 10 kg of the black sesame residue (10%), 6 kg of the black soldier fly larvae powder (6%), 6 kg of the fish bone powder (6%), 6 kg of the calcined oyster shell powder (6%), 5 kg of the rice husks (5%), 5 kg of the carbonized rice grain powder (5%), 1 kg of the maifan stone powder (1%), 0.5 kg of the fermented garlic (0.5%), and 0.5 kg of molasses (0.5%);
S5 (Step (5) addition of the solution of effective microorganisms): after the temperature of the mixture obtained in step (4) is cooled to below 45° C., one liter of the solution of effective microorganisms is added to the mixture and mixed homogeneously to obtain a feed mixture; and
S6 (Step (6) fermentation): fermenting the feed mixture obtained in step (5) anaerobically in an airtight plastic barrel for a month to obtain a fermented feed, wherein the fermented feed is the feed formulation containing black soldier fly protein.

In one aspect, the solution of effective microorganisms described in step (2) and step (5) contains lactic acid bacteria, yeast, photosynthetic bacteria, actinomycetes, acetic acid bacteria, and Aspergillus oryzae, wherein the lactic acid bacteria are preferably Lactobacillus buchneri.

In one aspect, in step (4), the nutrients further comprise an additional agricultural waste, including banana scraps, tomato scraps, orange peels or carrot scraps.

In another aspect, in step (4), the nutrients further comprise a Chinese herbal medicine, including calendula, honeysuckle, marigold, Rhinacanthus nasutus (L.) Kurz, Chinese yam, dendrobium, turmeric, angelica, ganoderma or cordyceps.

### Exemplary Embodiment 2: A Feed Formulation Containing Black Soldier Fly Protein Prepared by the Method Described in Exemplary Embodiment 1

In the feed formulation containing soybean curd residue prepared by the method described in Exemplary Embodiment 1, additional agricultural waste such as banana scraps, tomato scraps, orange peels, or carrots, and/or additional Chinese herbal medicine including calendula, honeysuckle, marigold, Rhinacanthus nasutus (L.) Kurz, Chinese yam, dendrobium, turmeric, angelica, Ganoderma or cordyceps can be added therein.

Further, earthworm powder can be additionally comprised in the feed formulation containing soybean curd residue, so that the feed formulation of the present invention contains not only plant protein, animal protein and insect protein, but also contains an annelid protein composition.

### Exemplary Embodiment 3: Effect of the Effective Microorganisms on the Growth and Bioconversion Rate of Black Soldier Fly Larvae

In the present embodiment, three different Effective Microorganisms (EM), such as EM1, EM6, and the combination of EM1 and EM6 (EM1+EM6), were used to examine the effect of various amounts of Effective Microorganisms, such as 10%, 20%, 30%, and 40% by weight, on the survival rate, development time, bioconversion rate, substrate consumption rate, and waste reduction of black soldier fly larvae. The EM1 is mainly lactic acid bacteria and photosynthetic bacteria, and the EM 6 is photosynthetic bacteria. Additionally, the content of photosynthetic bacteria in the combination of EM1 and EM 6 is higher than that of both EM 1 and EM 6.

TABLE 1
Growth status of black soldier flies with different proportions of
Effective Microorganisms (EM1)

| | | Develop- | | Substrate | |
|---|---|---|---|---|---|
| | | ment | Biocon- | con- | |
| | Survival | time of the | version | sumption | Waste |
| | rate | larvae | rate | rate | reduction |
| | (%) | (day) | (%) | (—) | (%) |
| 10% | 95.40 ± | 12.08 ± 0.01 | 10.90 ± 0.10 | 6.74 ± 0.10 | 73.48 ± 0.90 |
| (EM1) | 0.20 | | | | |
| 20% | 95.80 ± | 12.04 ± 0.02 | 10.95 ± 0.10 | 6.73 ± 0.50 | 73.63 ± 0.70 |
| (EM1) | 0.20 | | | | |
| 30% | 96.20 ± | 11.29 ± 0.01 | 10.99 ± 0.22 | 6.72 ± 0.20 | 73.91 ± 0.50 |
| (EM1) | 0.20 | | | | |
| 40% | 97.20 ± | 11.25 ± 0.01 | 11.14 ± 0.10 | 6.65 ± 0.10 | 74.03 ± 0.20 |
| (EM1) | 0.40 | | | | |

TABLE 2
Length and weight of black soldier fly larvae raised with different
proportions of Effective Microorganisms (EM1)

| | Length(cm) | Weight(g) |
|---|---|---|
| 10% (EM1) | 1.74 ± 0.11 | 0.18 ± 0.01 |
| 20% (EM1) | 1.77 ± 0.14 | 0.18 ± 0.01 |
| 30% (EM1) | 1.85 ± 0.08 | 0.19 ± 0.01 |
| 40% (EM1) | 1.91 ± 0.08 | 0.20 ± 0.01 |

From Table 1 and Table 2, the results of the tests on the addition of different proportions (10%, 20%, 30%, 40%) of the EM1 for the cultivation of black soldier fly larvae were that the addition of 40% of EM1 was able to obtain a higher survival rate, shorten more development time of larvae, increase more bioconversion rate, and reduce more waste compared to the other proportions. Furthermore, the addition of 40% of EM1 also produced longer and heavier black soldier fly larvae.

TABLE 3
Growth status of black soldier flies raised with different proportions of
Effective Microorganisms (EM6)

| | | Develop- | | Substrate | |
|---|---|---|---|---|---|
| | | ment | Biocon- | con- | |
| | Survival | time of the | version | sumption | Waste |
| | rate | larvae | rate | rate | reduction |
| | (%) | (day) | (%) | (—) | (%) |
| 10% | 95.20 ± | 12.25 ± 0.03 | 10.88 ± 0.10 | 6.71 ± 0.10 | 73.02 ± 0.40 |
| (EM6) | 0.20 | | | | |
| 20% | 95.40 ± | 12.17 ± 0.03 | 10.90 ± 0.10 | 6.71 ± 0.20 | 73.19 ± 0.60 |
| (EM6) | 0.40 | | | | |
| 30% | 96.00 ± | 11.33 ± 0.01 | 10.97 ± 0.20 | 6.69 ± 0.20 | 73.43 ± 0.20 |
| (EM6) | 0.40 | | | | |
| 40% | 97.00 ± | 11.25 ± 0.02 | 11.11 ± 0.10 | 6.66 ± 0.10 | 74.04 ± 0.10 |
| (EM6) | 0.20 | | | | |

TABLE 4
Length and weight of black soldier fly larvae raised with different
proportions of Effective Microorganisms (EM6)

| | Length (cm) | Weight (g) |
|---|---|---|
| 10% (EM6) | 1.68 ± 0.13 | 0.18 ± 0.01 |
| 20% (EM6) | 1.71 ± 0.12 | 0.18 ± 0.01 |
| 30% (EM6) | 1.78 ± 0.10 | 0.19 ± 0.01 |
| 40% (EM6) | 1.90 ± 0.10 | 0.20 ± 0.01 |

From Table 3 and Table 4, the results of the tests on the addition of different proportions (10%, 20%, 30%, 40%) of the EM6 for the cultivation of black soldier fly larvae were that the addition of 40% of EM6 was able to obtain a higher survival rate, shorten more development time of larvae, increase more bioconversion rate, and reduce more waste compared to the other proportions. Furthermore, the addition of 40% of EM6 also produced longer and heavier black soldier fly larvae.

From the above results, it can be inferred that the addition of a higher quantity of Effective Microorganisms (either EM1 or EM6) can help the black soldier fly larvae to grow and improve their bioconversion rates. Therefore, the present embodiment further tested the effect of different quantities of the combination of EM1 and EM6 (EM1+EM6) on the survival rate, development time, bioconversion rate, substrate consumption rate and waste reduction of black soldier fly larvae.

TABLE 5
Growth status of black soldier flies raised with different proportions of
Effective Microorganisms (EM1 + EM6)

| | | Development | | Substrate | |
|---|---|---|---|---|---|
| | | time of the | Bioconversion | consumption | Waste |
| | Survival rate | larvae | rate | rate | reduction |
| | (%) | (day) | (%) | (—) | (%) |
| 10% (EM1 + EM6) | 96.20 ± 0.20 | 11.21 ± 0.01 | 10.80 ± 0.10 | 6.77 ± 0.50 | 73.18 ± 0.50 |
| 20% (EM1 + EM6) | 96.60 ± 0.40 | 11.13 ± 0.02 | 11.01 ± 0.10 | 6.73 ± 0.10 | 74.12 ± 0.40 |
| 30% (EM1 + EM6) | 97.60 ± 0.20 | 11.08 ± 0.01 | 11.66 ± 0.20 | 6.55 ± 0.20 | 76.39 ± 0.40 |
| 40% (EM1 + EM6) | 98.20 ± 0.20 | 11.04 ± 0.04 | 11.81 ± 0.20 | 6.55 ± 0.10 | 77.27 ± 0.60 |

TABLE 6
Length and weight of black soldier fly larvae raised with different
proportions of Effective Microorganisms (EM1 + EM6)

| | Length (cm) | Weight (g) |
|---|---|---|
| 10% (EM1 + EM6) | 1.78 ± 0.11 | 0.19 ± 0.01 |
| 20% (EM1 + EM6) | 1.83 ± 0.08 | 0.19 ± 0.01 |
| 30% (EM1 + EM6) | 1.90 ± 0.12 | 0.21 ± 0.01 |
| 40% (EM1 + EM6) | 1.92 ± 0.14 | 0.21 ± 0.02 |

From Table 5 and Table 6, the results of the tests on the addition of different proportions (10%, 20%, 30%, 40%) of the combination of EM1 and EM6 (EM1+EM6) for the cultivation of black soldier fly larvae were that the addition of 40% of EM1+EM6 was able to obtain a higher survival rate, shorten more development time of larvae, increase more bioconversion rate, and reduce more waste compared to the other proportions. Furthermore, the addition of 40% of EM1+EM6 also produced longer and heavier black soldier fly larvae.

In addition, by comparing the data in Tables 1 to 6, it can be found that 40% of EM1+EM6 can obtain a higher survival rate, shorten more development time of larvae, increase more bioconversion rate, and reduce more waste compared to 40% of EM1 or EM6 alone. Furthermore, the addition of 40% of EM1+EM6 can also obtain longer and heavier black soldier fly larvae. Therefore, with the addition of 40% of EM1+EM6 for the cultivation of black soldier flies, more saturated fatty acids and protein from the black soldier fly larvae can be obtained more efficiently, and the black soldier fly larvae cultivated in this manner can later be used to prepare the feed formulation containing black soldier fly protein with high nutritional value according to the present invention. Further, while preparing the feed formulation containing black soldier fly protein according to the present invention, cultivation of black soldier fly larvae by using 40% of EM1+EM6 can more efficiently decompose organic waste of soybean curd residue.

### Exemplary Embodiment 4: Cultivation of Black Soldier Fly Larvae with Soybean Curd Residue of Different Pretreatment Methods

To examine the effect of soybean curd residue of different pretreatment methods on the survival rate, development time, bioconversion rate, substrate consumption rate, and waste reduction of black soldier fly larvae, the present embodiment used soybean curd residue of different pretreatment methods to cultivate black soldier fly larvae, and the black soldier fly larvae were cultivated respectively on the following conditions: T₀: soybean curd residue without pretreatment; T₁: soybean curd residue with Effective Microorganisms; T₂: soybean curd residue sterilized at high temperature; and T₃: soybean curd residue that was added with Effective Microorganisms after high-temperature sterilization. The soybean curd residue used in the present embodiment and in the present invention was obtained from the organic waste of soybean curd residue produced by soybean product manufacturers in the market during the production process.

TABLE 7
Growth status of black soldier fly larvae raised on soybean
curd residue of different pretreatments

| | | Develop- | | Substrate | |
|---|---|---|---|---|---|
| | Survival | ment | Bio- | con- | |
| | | time of the | conversion | sumption | Waste |
| | rate | larvae | rate | rate | reduction |
| | (%) | (day) | (%) | (—) | (%) |
| T₀ | 96.47 ± 0.23 | 12.59 ± 0.06 | 9.51 ± 0.17 | 7.26 ± 0.17 | 69.00 ± 0.48 |
| T₁ | 95.40 ± 0.53 | 12.65 ± 0.06 | 9.20 ± 0.22 | 7.35 ± 0.32 | 67.59 ± 2.35 |
| T₂ | 94.87 ± 0.61 | 12.77 ± 0.25 | 8.86 ± 0.74 | 7.41 ± 0.61 | 65.31 ± 0.75 |
| T₃ | 97.67 ± 0.12 | 11.70 ± 0.20 | 10.72 ± 0.13 | 6.48 ± 0.08 | 69.49 ± 0.28 |

T₀: soybean curd residue without pretreatment;
T₁: soybean curd residue with Effective Microorganisms;
T₂: soybean curd residue sterilized at high temperature;
T₃: soybean curd residue that was added with Effective Microorganisms after high-temperature sterilization

TABLE 8
Length and weight of black soldier fly larvae raised on soybean curd
residue of different pretreatments

| | Length (cm) | Weight (g) |
|---|---|---|
| T₀ | 1.64 ± 0.14 | 0.17 ± 0.01 |
| T₁ | 1.63 ± 0.14 | 0.17 ± 0.02 |
| T₂ | 1.61 ± 0.14 | 0.17 ± 0.01 |
| T₃ | 1.76 ± 0.10 | 0.19 ± 0.01 |

From Table 7 and Table 8, the results of cultivating black solider flies on soybean curd residue of different pretreatments show that direct addition of Effective Microorganisms to the decayed soybean curd residue (T₁) did not have a positive effect on the development of black soldier fly larvae, probably because the soybean curd residue already had too many miscellaneous bacteria, which were not conducive to the growth of black soldier fly larvae. Soybean curd residue (T₂) that was only sterilized at high temperature to remove miscellaneous bacteria did not improve the development of black soldier fly larvae either. However, the decayed soybean curd residue (T₃) that was added with Effective Microorganisms after high-temperature sterilization was more beneficial to the development of black soldier fly larvae. Tables 7 and 8 clearly show that the cultivation of black soldier fly larvae on soybean curd residue, which is sterilized at high temperature and followed by the addition of Effective Microorganisms, led to a better survival rate, shorter development time of the larvae, higher bioconversion rate, and more waste reduction. In addition, longer and heavier black soldier fly larvae can also be obtained by raising black soldier fly larvae on the soybean curd residue that is sterilized at high temperature and followed by the addition of Effective Microorganisms. Therefore, in the method for preparing a feed formulation containing black soldier fly protein according to the present application, black soldier fly larvae were raised on soybean curd residue that has been sterilized at high temperature and supplemented with Effective Microorganisms. Then, the cultivation time of black soldier fly larvae can be shortened, and longer and heavier black soldier fly larvae can be obtained. By using longer, heavier black soldier fly larvae to prepare black soldier fly larvae powder, more saturated fatty acids and protein can be efficiently obtained from the black soldier fly larvae. Later, the prepared black soldier fly larvae powder can be used to prepare the feed formulation containing black soldier fly protein with high nutritional value according to the present invention. Further, organic waste of soybean curd residue can be decomposed more efficiently while preparing the feed formulation containing black soldier fly protein according to the present invention.

### Exemplary Embodiment 5: Cultivation of Black Soldier Fly Larvae with Substrates of Different Ratios of Soybean Curd Residue to Rice

In the present embodiment, substrates of different ratios of soybean curd residue to rice were used to cultivate black soldier fly larvae. The black soldier fly larvae were raised on the following substrates of different ratios (weight ratios) of soybean curd residue to rice: R₀ is 5:0, R₁ is 4:1, R₂ is 3:2, R₃ is 2:3, and R₄ is 1:4, to examine the effect of substrates of various ratios of soybean curd residue to rice on the survival rate, development time, bioconversion rate, substrate consumption rate, and waste reduction of black soldier fly larvae. The rice used in the present embodiment was prepared by steaming commercially available packaged rice in an electronic rice cooker and then placing the cooked rice in an anaerobic environment for one week for fermentation.

TABLE 9
Growth status of black soldier fly larvae raised on substrates of
different ratios of soybean curd residue to rice

| | | Development | | Substrate | |
|---|---|---|---|---|---|
| | Survival | time of the | Biocon- | con- | Waste |
| | rate | larvae | version | sumption | reduction |
| | (%) | (day) | rate (%) | rate (—) | (%) |
| R₀ | 98.20 ± 0.20 | 11.04 ± 0.04 | 11.81 ± 0.20 | 6.55 ± 0.10 | 77.27 ± 0.60 |
| R₁ | 98.33 ± 0.12 | 10.78 ± 0.02 | 12.19 ± 0.01 | 6.53 ± 0.02 | 77.72 ± 0.73 |
| R₂ | 98.60 ± 0.40 | 10.23 ± 0.01 | 12.53 ± 0.05 | 6.34 ± 0.01 | 79.50 ± 0.26 |
| R₃ | 98.47 ± 0.31 | 10.40 ± 0.04 | 12.33 ± 0.04 | 6.35 ± 0.03 | 78.29 ± 0.12 |
| R₄ | 95.20 ± 0.20 | 11.27 ± 0.05 | 11.35 ± 0.02 | 6.63 ± 0.21 | 75.23 ± 2.41 |

The mixing ratios of soybean curd residue to rice in the substrates: R₀ is 5:0, R₁ is 4:1, R₂ is 3:2, R₃ is 2:3, and R₄ is 1:4.

TABLE 10
Length and weight of black soldier fly larvae raised on substrates of
different ratios of soybean curd residue to rice

| | Length (cm) | Weight (g) |
|---|---|---|
| R₀ | 1.92 ± 0.14 | 0.21 ± 0.02 |
| R₁ | 1.93 ± 0.13 | 0.21 ± 0.01 |
| R₂ | 2.01 ± 0.14 | 0.22 ± 0.02 |
| R₃ | 1.94 ± 0.15 | 0.22 ± 0.02 |
| R₄ | 1.74 ± 0.15 | 0.18 ± 0.02 |

From Table 9 and Table 10, the results of raising black soldier fly larvae with different ratios of soybean curd residue to rice show that raising black soldier fly larvae with the R₂ ratio of 3:2 (i.e., the proportion of soybean curd residue to rice in the substrate was 60% to 40%) resulted in higher survival rate, shorter development time of the larvae, better bioconversion rate, and more waste reduction. In addition, raising black soldier fly larvae with a ratio of soybean curd residue to rice of 3:2 also resulted in longer and heavier black soldier fly larvae. Therefore, in a method for preparing a feed formulation containing black soldier fly protein according to the present application, the black soldier fly larvae can be raised on a substrate with a ratio of soybean curd residue to rice of 3:2. Then, the cultivation time of black soldier fly larvae can be shortened, and longer and heavier black soldier fly larvae can be obtained. Therefore, by using longer, heavier black soldier fly larvae to prepare black soldier fly larvae powder, more saturated fatty acids and protein can be efficiently obtained from the black soldier fly larvae. Later, the prepared black soldier fly larvae powder can be used to prepare the feed formulation containing black soldier fly protein with high nutritional value according to the present invention. Further, organic waste of soybean curd residue can be decomposed more efficiently while preparing the feed formulation containing black soldier fly protein according to the present invention.

### Exemplary Embodiment 6: Cultivation of Black Soldier Fly Larvae with Substrates of Different Ratios of Soybean Curd Residue to Bokashi

In the present embodiment, substrates of different ratios of soybean curd residue to Bokashi were used to cultivate black soldier fly larvae. The black soldier fly larvae were raised respectively on the following substrates of different ratios (weight ratios) of soybean curd residue to Bokashi: B₀ is 5:0, B₁ is 4:1, B₂ is 3:2, B₃ is 2:3, and B₄ is 1:4, to examine the effect of substrates of various ratios of soybean curd residue to Bokashi on the survival rate, development time, bioconversion rate, substrate consumption rate, and waste reduction of black soldier fly larvae. The Bokashi used in the present embodiment was prepared by mixing various organic materials (rice bran, black sesame residue, fish bone powder, oyster shell powder, and carbonized rice grain powder) with EM1 and EM6 and then fermenting them for one month in an anaerobic environment.

TABLE 11
Growth status of black soldier fly larvae raised on substrates of
different ratios of soybean curd residue to Bokashi

| | | Development | Biocon- | | |
|---|---|---|---|---|---|
| | Survival | time of the | version | Substrate | Waste |
| | rate | larvae | rate | consumption | reduction |
| | (%) | (day) | (%) | rate (—) | (%) |
| B₀ | 98.20 ± 0.20 | 11.04 ± 0.04 | 11.81 ± 0.20 | 6.55 ± 0.10 | 77.27 ± 0.60 |
| B₁ | 98.47 ± 0.04 | 10.30 ± 0.01 | 12.41 ± 0.01 | 6.35 ± 0.01 | 80.11 ± 0.08 |
| B₂ | 98.73 ± 0.12 | 10.21 ± 0.01 | 12.72 ± 0.02 | 6.32 ± 0.02 | 80.40 ± 0.31 |
| B₃ | 98.33 ± 0.31 | 10.38 ± 0.04 | 12.35 ± 0.04 | 6.37 ± 0.01 | 78.71 ± 0.13 |
| B₄ | 96.73 ± 0.31 | 11.18 ± 0.07 | 11.70 ± 0.04 | 6.57 ± 0.03 | 76.88 ± 0.24 |

TABLE 12
Length and weight of black soldier fly larvae raised on substrates of
different ratios of soybean curd residue to Bokashi

| | Length (cm) | Weight (g) |
|---|---|---|
| B₀ | 1.92 ± 0.14 | 0.21 ± 0.02 |
| B₁ | 2.02 ± 0.10 | 0.21 ± 0.01 |
| B₂ | 2.06 ± 0.07 | 0.23 ± 0.02 |
| B₃ | 1.93 ± 0.18 | 0.20 ± 0.02 |
| B₄ | 1.77 ± 0.15 | 0.19 ± 0.01 |

From Table 11 and Table 12, the results of raising black soldier fly larvae with different ratios of soybean curd residue to Bokashi show that raising black soldier fly larvae with the B₂ ratio of 3:2 (i.e., the proportion of soybean curd residue to Bokashi in the substrate was 60% to 40%) resulted in higher survival rate, shorter development time of the larvae, better bioconversion rate, and more waste reduction. In addition, raising black soldier fly larvae with a ratio of soybean curd residue to Bokashi of 3:2 also resulted in longer and heavier black soldier fly larvae. Moreover, when compared with Exemplary Embodiments 1 to 5 above, the best results were obtained by raising black soldier fly larvae on the substrate with a ratio of soybean curd residue to Bokashi of 3:2 because the highest survival rate, the shortest development time of the larvae, the highest bioconversion rate, and the most waste reduction were obtained. Therefore, in a method of preparing a feed formulation containing soybean curd residue according to the present application, black soldier fly larvae can also be raised on a substrate with a ratio of soybean curd residue to Bokashi of 3:2, in which not only can the cultivation time of black soldier fly larvae be shortened, but also longer and heavier black soldier fly larvae can be obtained. By using the longer and heavier black soldier fly larvae to prepare the black soldier fly larvae powder, more saturated fatty acids and protein can be efficiently obtained from the black soldier fly larvae. Then, the prepared black fly soldier larvae powder can be used to prepare the feed formulation containing soybean curd residue with high nutritional value according to the present invention. Furthermore, organic waste of soybean curd residue can be decomposed more efficiently while preparing the feed formulation containing soybean curd residue according to the present invention.

### Exemplary Embodiment 7: Effect of a Feed Formulation Containing Soybean Curd Residue on Egg Production Rate and Cholesterol in Eggs

In the present embodiment, the feed formulation containing soybean curd residue according to the present invention and the commercially available feed formulation were used to feed egg-laying hens, and then the egg production rate and cholesterol content in the eggs laid by the egg-laying hens fed with different feed formulations was measured, wherein the feed formulation containing soybean curd residue is a feed formulation containing black soldier fly protein prepared by the method described in Exemplary Embodiment 1.

TABLE 13
Egg production rate in the eggs laid by the egg-laying hens fed with
different feed formulations

| | Egg production rate (%) |
|---|---|
| F₁ | 88 |
| F₂ | 76 |

F₁: Eggs obtained by feeding egg-laying hens with a feed formulation containing soybean curd residue
F₂: Eggs obtained by feeding egg-laying hens with a commercially available feed formulation

As can be seen from Table 13, the egg production rate in the eggs obtained by feeding egg-laying hens with the feed formulation containing soybean curd residue according to the present invention was significantly higher than that of the eggs obtained by feeding egg-laying hens with commercially available feed formulation, with a increase of 12%.

TABLE 14
Cholesterol content in the eggs laid by the egg-laying hens fed with
different feed formulations

| | Cholesterol content (mg/per egg) |
|---|---|
| F₁ | 167 |
| F₂ | 240 |

F₁: Eggs obtained by feeding egg-laying hens with a feed formulation containing soybean curd residue
F₂: Eggs obtained by feeding egg-laying hens with a commercially available feed formulation

As can be seen from Table 14, the cholesterol content in the eggs obtained by feeding egg-laying hens with the feed formulation containing soybean curd residue according to the present invention was significantly less than that of the eggs obtained by feeding egg-laying hens with commercially available feed formulation, with a reduction of 73 mg of cholesterol, i.e., a considerable reduction of 30.4% in cholesterol content.

As can be seen from the above exemplary embodiments, the feed formulation containing soybean curd residue prepared by the method of the present invention contains animal protein (fish bone powder), vegetable proteins (soybean curd residue, sesame residue, etc.), insect protein (black soldier fly larvae), and recycled minerals (oyster shells), etc. and comprises many beneficial ingredients for the growth of organisms. The nutritional value of the feed formulation containing soybean curd residue is very high, so it is very suitable as feed for livestock, poultry, and aquatic animals. In addition, the cholesterol content of the eggs obtained by feeding egg-laying hens with the feed formulation according to the present invention is significantly lower, thus meeting the needs of modern people in pursuit of a healthy diet.

The above descriptions have thoroughly introduced the feed formulation containing soybean curd residue according to the present invention and method for preparing the same. It should be emphasized that the above descriptions are made on embodiments of the present invention; however, the embodiments are not intended to limit the scope of the present invention, and all equivalent implementations or alterations within the spirit of the present invention still fall within the scope of the present invention.

What is claimed is:

1. A method for preparing a feed formulation containing soybean curd residue, comprising the following steps:
(1) sterilization: sterilizing a soybean curd residue at 70° C. for 30 minutes to obtain a sterilized soybean curd residue, and dividing the sterilized soybean curd residue into two portions: a portion A and a portion B;
(2) preparation of a feed for black soldier fly: mixing the portion A with 5% w/w of a solution of effective microorganisms to obtain the feed for black soldier fly;
(3) preparation of a black soldier fly larvae powder: cultivating black soldier fly larvae on the feed for black soldier fly, collecting the black soldier fly larvae after 18 days of cultivation, and drying and grinding the black soldier fly larvae to obtain the black soldier fly larvae powder;
(4) addition of nutrients and the black soldier fly larvae powder: adding the black soldier fly larvae powder and the following nutrients to the portion B: rice bran, black sesame residue, fish bone powder, calcined oyster shell powder, rice husks, carbonized rice grain powder, maifan stone powder, fermented garlic, molasses, and mixing homogeneously to obtain a mixture, wherein every 100 kg of the mixture contains 20 kg of the portion B (20%), 40 kg of the rice bran (40%), 10 kg of the black sesame residue (10%), 6 kg of the black soldier fly larvae powder (6%), 6 kg of the fish bone powder (6%), 6 kg of the calcined oyster shell powder (6%), 5 kg of the rice husks (5%), 5 kg of the carbonized rice grain powder (5%), 1 kg of the maifan stone powder (1%), 0.5 kg of the fermented garlic (0.5%), and 0.5 kg of molasses (0.5%);
(5) addition of the solution of effective microorganisms: after the temperature of the mixture obtained in step (4) is cooled to below 45° C., one liter of the solution of effective microorganisms is added to the mixture and mixed homogeneously to obtain a feed mixture; and
(6) fermentation: fermenting the feed mixture obtained in step (5) anaerobically in an airtight plastic barrel for a period to obtain a fermented feed, wherein the fermented feed is the feed formulation containing soybean curd residue.

2. The method of claim 1, wherein the solution of effective microorganisms comprises lactic acid bacteria, yeast, photosynthetic bacteria, actinomycetes, acetic acid bacteria, and Aspergillus oryzae.

3. The method of claim 1, wherein in step (4), the nutrients further comprise an additional agricultural waste, including banana scraps, tomato scraps, orange peels or carrot scraps.

4. The method of claim 1, wherein in step (4), the nutrients further comprise a Chinese herbal medicine, including calendula, honeysuckle, marigold, Rhinacanthus nasutus (L.) Kurz, Chinese yam, dendrobium, turmeric, angelica, ganoderma or cordyceps.

5. The method of claim 1, wherein in step (6), the period for anaerobically fermenting the feed mixture is 1 month.

6. A feed formulation containing soybean curd residue prepared by the method of claim 1.

7. The feed formulation containing soybean curd residue of claim 6, wherein the feed formulation containing black soldier fly protein further comprises an additional agricultural waste, including banana scraps, tomato scraps, orange peels or carrot scraps.

8. The feed formulation containing soybean curd residue of claim 6, wherein the feed formulation containing black soldier fly protein further comprises a Chinese herbal medicine, including calendula, honeysuckle, marigold, Rhinacanthus nasutus (L.) Kurz, Chinese yam, dendrobium, turmeric, angelica, ganoderma or cordyceps.

9. The feed formulation containing soybean curd residue of claim 6, wherein the feed formulation containing black soldier fly protein further comprises earthworm powder.

10. The feed formulation containing soybean curd residue of claim 6, wherein the feed formulation containing black soldier fly protein can be used as feed for livestock, poultry, or aquatic animals.
